(19) United States
(12) Patent Application Publication
(10) Pub. No.: US 2004/0011297 A1
(43) Pub. Date: Jan. 22, 2004

(54) Canine waste receptacle

(76) Inventor: Brandon R. Hochman, Los Angeles, CA (US)

Correspondence Address: TROJAN LAW OFFICES, 9250 WILSHIRE BLVD, SUITE 325, BEVERLY HILLS, CA, 90212

(21) Appl. No.: 10/199,197

(22) Filed: Jul. 19, 2002

(51) Int. Cl. A01K 29/00

(52) U.S. Cl. 119/165

(57) ABSTRACT

A canine waste receptacle providing a natural, sanitary, hassle-free environment in which canines may urinate and deficate indoors. The canine waste receptacle has a layer of sod which rests upon a base. The base has apertures which allow urine and excess water to pass through to a collection tray which is housed underneath the base. This collection tray may be removed in order to dispose of the excess waste.

### BACKGROUND OF THE INVENTION

The present invention relates to indoor animal waste receptacles. Specifically, this invention teaches a convenient and sanitary manner by which canines may relieve their bladder or bowel indoors.

Dog owners are responsible for the care for and nurturing of their dogs. One every day aspect of dog care includes providing a place where a dog can relieve its bladder or bowel. In rural areas, this is often not a problem, however, in big cities, dog owners are often left with no choice other than to take the dog out in the middle of the city. This proposition is made even more burdensome due to city ordinances imposing fines should the owner fail to clean up after the dog.

The present invention provides a sanitary means by which a dog may relieve itself indoors. It provides the dog a natural environment (grass) upon which it may relieve itself. The invention is designed to promote the growth of the grass while allowing for easy clean up and disposal of the waste. From the animal's perspective, this invention allows the dog the freedom to relieve itself at any time. No longer is the dog tied to the owner's schedule.

For the foregoing reasons, there is a need for a canine waste receptacle that will allow dogs to expend themselves indoors in a sanitary manner.

### SUMMARY OF THE INVENTION

The present invention relates to an apparatus that satisfies the need for a user friendly, sanitary canine waste receptacle. A canine waste receptacle having features of the present invention comprises a base which is supported by side walls. On top of the base lies sod providing the dog with a natural grass environment upon which the dog may urinate or deficate. Beneath the base is a collection tray. The tray is supported by the side walls and can slide in and out of the apparatus.

The base itself has openings through which excess liquids may pass. As urine is toxic to grass, the openings allow it to pass through to the collection tray. This enables the grass to last longer. Access to the collection tray is through a side wall which may be either removed or swung open. The collection tray can then be removed and its contents disposed of.

### BRIEF DESCRIPTION OF THE DRAWINGS

The features and advantages of this invention are better understood with regard to the following drawings, description, and claims. The drawings consist of the following:

FIG. 1 is a perspective view of an apparatus embodying features of this invention.

FIG. 2 is a top plan view of an apparatus embodying features of this invention.

FIG. 3 is a front view of an apparatus embodying features of this invention.

FIG. 4 is a cross-sectional side view of an apparatus embodying features of this invention.

FIG. 5 is another top plan view of an apparatus embodying features of this invention.

FIG. 6 is another cross-sectional side view of an apparatus embodying features of this invention.

FIG. 7 is another cross-sectional side view of an apparatus embodying features of this invention.

FIG. 8 is a perspective view of an apparatus embodying features of the collection tray.

### DESCRIPTION OF THE INVENTION

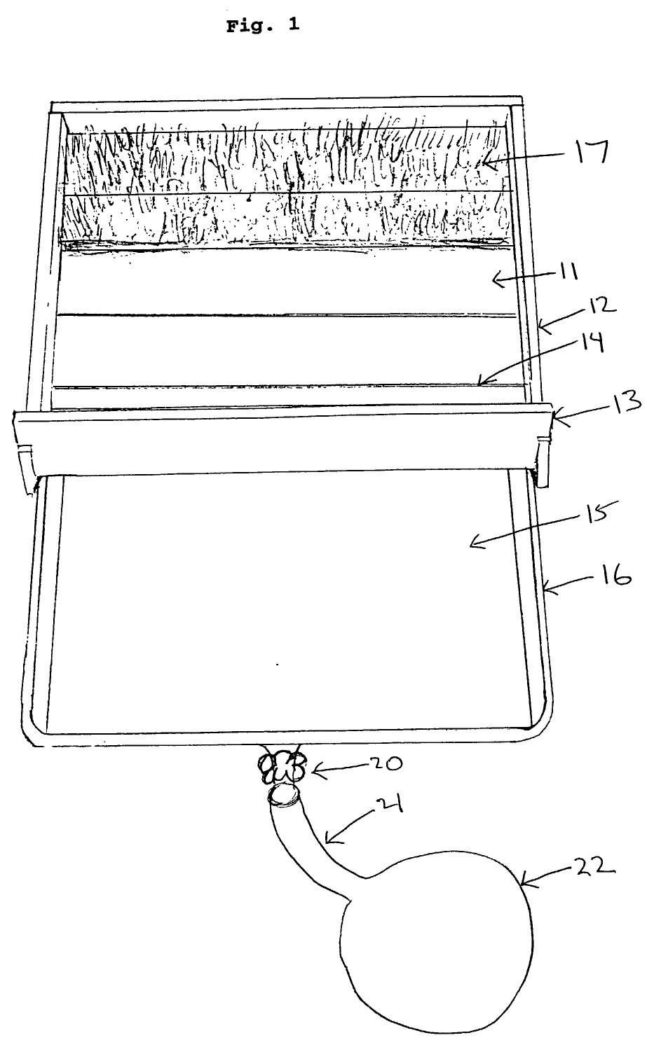

As shown in FIG. 1, a canine waste receptacle comprises a base 11, permanently affixed side walls 12 to the base, at least one detachable side wall 13, at least one aperture 14 through which excess liquids may pass, a layer of sod 17 on top of the base, and a collection tray 15 into which the liquids are collected. The base 11 may be any shape, however, the preferable shape is that of a square or rectangle in order to accommodate the shape in which commercial sod is sold. Sod is commonly sold in 16″×16″ squares.

The size of the base 11 may vary, the preferable size being one sufficient to allow any size dog to comfortably stand. Four 16″×16″, squares of sod provide sufficient square footage for most dogs. Accordingly, the dimensions of the base 11 are preferably 32″×32″. The base 11 is best made out of an impervious, rigid, lightweight material sufficient to support the weight of both the sod and a dog. Plastics such as poly-vinyl tend to have these characteristics, however, wood or stainless steel could easily be used in place of plastic.

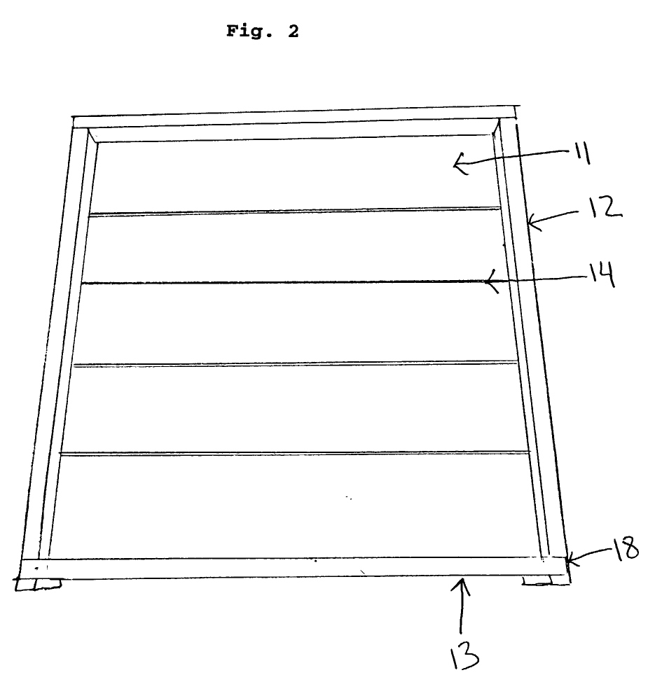

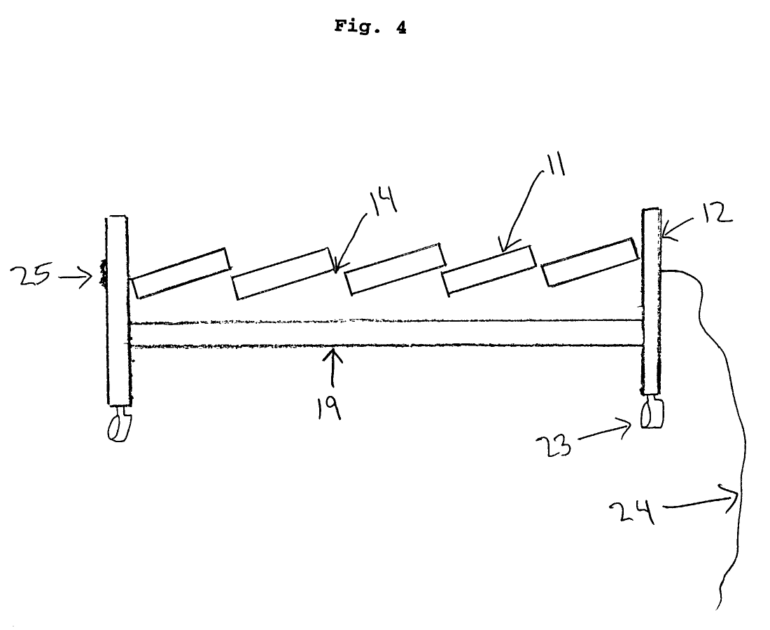

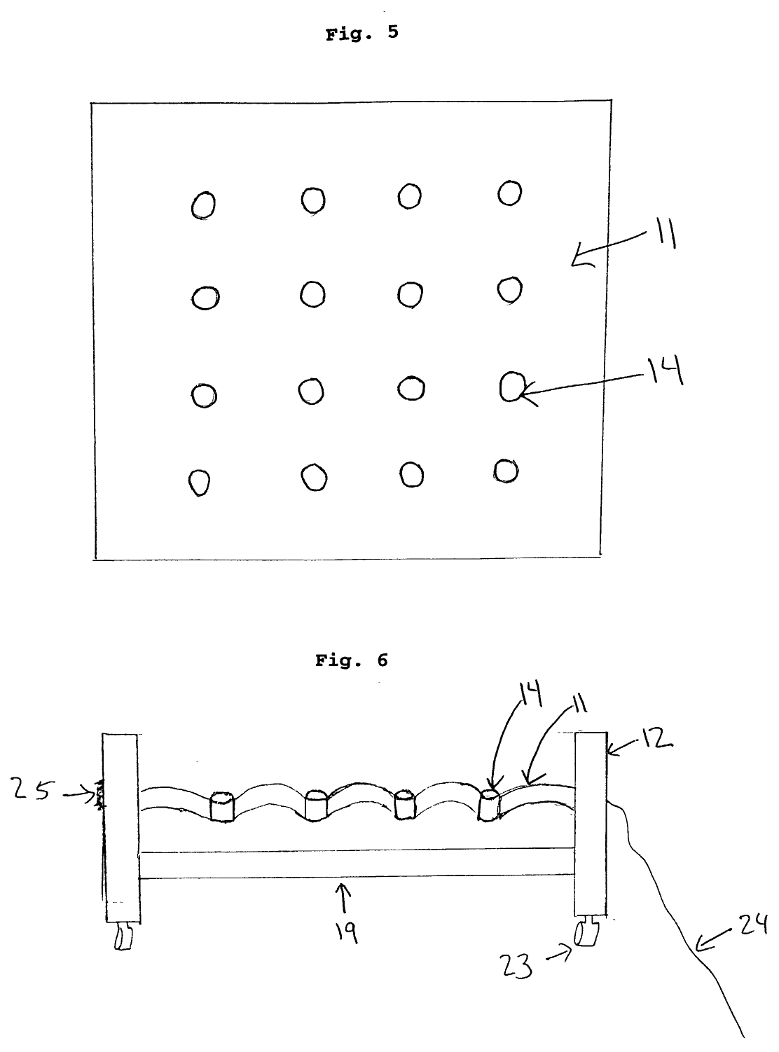

The base 11 may be comprised of four to six boards which are supported by the permanently affixed side walls 12. The boards are preferably spaced at least ½ inch apart, creating an aperture 14 through which excess liquids may drain. FIG. 2 is a top plan view of an apparatus with five boards supported by the permanently affixed side walls 12. The apertures 14 are demonstrated by the space left between the boards. The boards may also be attached to the permanently affixed side walls 12 such that each board is tilted 5-10 degrees from horizontal. FIG. 4 is a cross sectional side view of the apparatus demonstrating each board set 5-10 degrees off horizontal. This would further promote drainage, while still maintaining adequate support for the sod 17 and canine. In still another embodiment, the base 11 may be comprised of one board which has holes of a diameter of at least ½ inch, spaced at least every two inches. FIG. 5 is a top plan view of the base 11 with holes as apertures 14. This would provide adequate drainage, while providing adequate support. In addition, these holes may be placed in a depression, thereby further utilizing the effects of gravity in promoting drainage. FIG. 6 is a cross sectional view of an apparatus embodying the features of having holes placed in a depression throughout the base 11.

Permanently affixed side walls 12 to the base 11 may be made out of any impervious, rigid, lightweight material, preferably being the same material as that of the base. The permanently affixed side walls 12 extend above the base 11 in order to provide lateral support for the layer of sod 17. Sod is comprised of a plot of roots holding soil together with grass growing out of the soil. The roots and soil component of sod is approximately 1-3 inches thick. The permanently affixed side walls 12 preferably support this component of sod 17 extending at least one inch above the base 11.

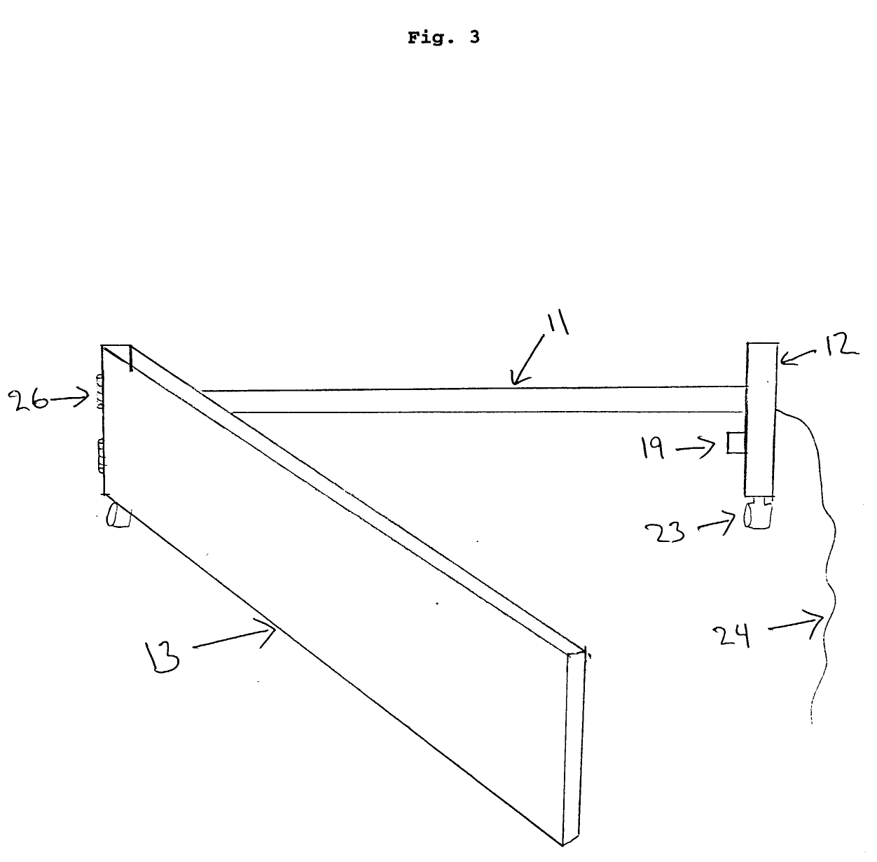

The permanently affixed side walls 12 extend below the base 11 in order to provide support for the collection tray 15. Appendages 19 (FIG. 3) below the base 11 and affixed to the permanent side walls 12 provide support for the collection tray 15. Appendages 19 act as a track along which the collection tray 15 may rest. Appendages 19 must be of sufficient extension so as to provide support for the collection tray 15 while allowing the collection tray 15 to slide in and out. Preferably the appendages 19 should extend at least one inch inward. This extension would then provide an adequate shelf upon which the collection tray 15 may rest.

The collection tray 15 is made out of an impervious, rigid, lightweight material such as poly-vinyl plastic. The collection tray 15 has an upper lip 16 that rests upon and is supported by the appendages 19. The upper lip 16 of the collection tray 15 should extend out from the collection tray 15 at least one inch so that the upper lip 16 may rest on the appendage 19. The width of the collection tray 15 should be such that sufficient overlap exists between the upper lip 16 of the collection tray 15 and the appendage 19 in order to provide adequate support for the collection tray 15.

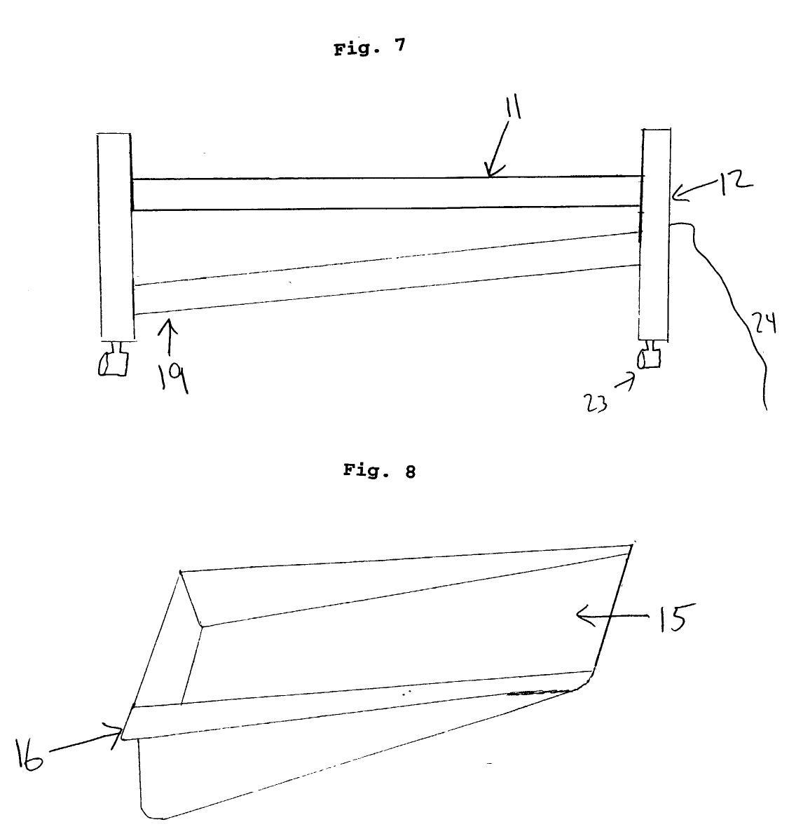

The front wall of the collection tray 15 may have a valve 20 through which excess fluids may be drained. In order to facilitate drainage the collection tray 15 should be slightly inclined towards the front wall of the collection tray 15. This may be accomplished by creating a slight decline in the tracking of the appendage 19. FIG. 7 is a cross sectional side view of an apparatus illustrating the slight decline in the appendage 19 track. Another means by which this may be accomplished is by gradually increasing the height of the side walls of the collection tray 15 from back to front. Then, when the collection tray 15 is placed on the appendages 19, the incline forward would lead to excess liquids collecting towards the front wall. FIG. 8 is a perspective view of a collection tray 15 with these embodiments. These liquids may then be disposed of through the valve 20.

Connected to the valve 20 is a hose 21 leading to a bladder 22. When the hose 21 is connected to the valve 21, and the bladder 22 is placed on the floor, the valve 21 may be turned on, and gravity will bring the contents of the collection tray 15 into the bladder 22.

Excess liquids may also be disposed of by removal of the collection tray 15. At least one detachable side wall 13 of the same size and shape of the permanently affixed side wall 12 is necessary to allow access to the collection tray 15. The detachable side wall 13 may slide in and out of notches 18 (FIG. 2) grooved into the permanent side walls 12. The detachable side wall 13 may also be attached by hinges 26 to the permanent affixed side wall, thereby allowing the detachable wall 13 to swing open and shut.

Wheels 23 and a cord 24 may also be secured to the permanently affixed side walls 12 in order to increase the mobility of the canine waste receptacle. In addition, a fastener 25, such as velcro may be secured to a permanently fixed wall such that the canine waste receptacle may be linked to another canine waste receptacle, or secured to another type of unit such as a dog house.

The aforementioned versions of the present invention have many advantages. It provides a sanitary, hassle free mechanism by which dogs may urinate or deficate indoors. The design of the canine waste receptacle allows toxic urine to pass through to the collection tray while still supporting the sod, thus enabling the grass to survive for longer periods of time. Additionally, it allows dogs the freedom to relieve themselves whenever they feel necessary, in their own natural environment.

Although the present invention has been described in detail with respect to certain preferred versions thereof, other versions are possible. Therefore, the scope of the claims should not be limited to the description of the preferred versions contained herein.

I claim:

1. A canine waste receptacle comprising:
(a) a base having at least one aperture,
(b) said base bounded by a plurality of side walls extending above and below said base, said plurality of side walls including at least one side wall permanently affixed to said base and at least one detachable side wall, said permanently affixed side walls having at least one appendage located below the base and extending inward;
(b) a collection tray with an upper lip extending outward whereby said collection tray lies beneath said base with said upper lip of said collection tray supported by and on top of said appendage of said permanently affixed side walls;
(c) a layer of sod resting on top of said base, supported by said permanent and detachable side walls.

2. The animal waste receptacle of claim 1, wherein said detachable side wall(s) are secured by at least one hinge.

3. The animal waste receptacle of claim 1 or 2 further comprising at least 3 wheels secured to the bottom wall of the container.

4. The animal waste receptacle of claim 1 or 2 further comprising at least one cord affixed to said permanently affixed or detachable side wall for pulling the receptacle.

5. The animal waste receptacle of claim 1 or 2 further comprising at least one fastener affixed to said permanently affixed side wall.

6. The animal waste receptacle of claim 1 or 2 wherein said collection tray has a valve affixed to the front of the collection tray.

7. A method for using the animal waste receptacle comprising the steps of:
(a) intermittently watering the sod layer;
(b) having the canine relieve their bladder or bowel on top of the receptacle; and
(c) disposing of excess liquids.
